(19) United States
(12) Patent Application Publication
(10) Pub. No.: US 2006/0019859 A1
(43) Pub. Date: Jan. 26, 2006

(54) Powder dilutable multi-surface cleaner

(76) Inventors: Melani Duran, Mesa, AZ (US); John Hudson, Scottsdale, AZ (US)

Correspondence Address: Damon L. Boyd;Snell & Wilmer L.L.P., One Arizona Center, 400 East Van Buren, Phoenix, AZ, 85004-2202, US

(21) Appl. No.: 10/898,662

(22) Filed: Jul. 23, 2004

(51) Int. Cl. C11D 17/00

(52) U.S. Cl. 510/445

(57) ABSTRACT

A dilutable multi-surface cleaner that comprises an anionic surfactant in an amount of from about 0.1% to about 5% by weight of the composition, a nonionic surfactant component in an amount of about 0.01% to about 5% by weight of the composition, a builder in an amount of from about 20% to about 60% by weight of the composition, a chelating agent in an amount from about 0.01% to about 5% by weight of the composition, a bleaching agent in an amount from about 30% to about 70% by weight of the composition, a buffering agent in an amount of from about 0% to about 15% by weight of the solution. The present invention may also comprises a bleach activator and flow aids.

### FIELD OF INVENTION

The present invention relates generally to a dilutable powder multi-surface cleaning composition. More particularly, the present invention relates to a powder that can be mixed with water to form an effective cleaner for laundry applications, as well as hard surface cleaning

### BACKGROUND OF THE INVENTION

There are a number of dilutable powder cleaners on the market today. The user can mix the powder with water to create a cleaning solution. In many cases, the cleaner can also be used in laundry applications. Often, these solutions are simple combinations of a builder and a bleaching agent.

There are a number of various cleaning agents known in the art that perform a variety of different functions to aid cleaning. Examples of such cleaning agents are used in dish washing detergents, laundry detergents, hard surface cleaners and the like.

What is needed is a dilutable powder cleaner that uses additional cleaning agents to enhance the performance of the cleaner in all of its capacities, such as, for example, hard surface cleaning, cleaning of fabrics, and use as a laundry detergent.

### SUMMARY OF THE INVENTION

The present invention provides a dilutable powder cleaning composition. The cleaning composition comprises an anionic surfactant component, a nonionic surfactant component, a builder, a chelating agent, a bleaching agent, buffering agent, and optional ingredients. The present invention relates to a powder that can be mixed with water to form an effective cleaner for laundry applications, as well as hard surface cleaning.

An exemplary embodiment of the present invention comprises a dilutable cleaner that comprises an anionic surfactant in an amount of from about 0.1% to about 5% by weight of the composition, a nonionic surfactant component in an amount of about 0.01% to about 5% by weight of the composition, a builder in an amount of from about 20% to about 60% by weight of the composition, a chelating agent in an amount from about 0.01% to about 5% by weight of the composition, a bleaching agent in an amount from about 30% to about 70% by weight of the composition, a buffering agent, preferably Borax, in an amount of from about 0% to about 15% by weight of the composition. A preferred embodiment of the present invention may also comprise a bleach activator and sodium alumino silicate hydrate.

### DETAILED DESCRIPTION

The following description is of an exemplary embodiment of the invention only, and is not intended to limit the scope, applicability, or configuration of the invention in any way. Rather, the following description is intended to provide a convenient illustration for implementing various aspects of the exemplary embodiment of the invention. As will become apparent, changes may be made in the function and arrangement of the elements described in this, embodiment without departing from the spirit and scope of the invention.

That being said, generally, in accordance with the present invention, a dilutable powdered cleaning composition is provided. For example, in accordance with various aspects of the present invention, the cleaning composition includes an anionic surfactant component, a nonionic surfactant component, a builder, a chelating agent, a bleaching agent, and a buffering agent. Additionally, the cleaning composition may also comprise a bleach activator and sodium alumino silicate hydrate.

The nonionic surfactant component is present in the amount of from about 0.01% to about 5% by weight of the composition. More preferably, the nonionic surfactant component is present in the amount from about 0.05% to about 2% by weight of the composition, and most preferably is present in the amount of from about 0.1% to about 1% by weight of the composition.

In one aspect of the exemplary embodiment of the present invention, the nonionic surfactant component comprises ethoxylated alcohols. More preferably, the nonionic surfactant comprises C9-C11 ethoxylated alcohols. Optimally, a narrow range ethoxylate is used giving fast penetration of fatty soils and improved performance on hard surfaces. Suitable nonionic surfactants include, in particular, the reaction products of compounds having a hydrophobic group and a reactive hydrogen atom, for example aliphatic alcohols, acids, amides or alkyl phenols with alkylene oxides, especially ethylene oxide either alone or with propylene oxide. Specific nonionic detergent compounds are alkyl (C₈-C₁₈) primary or secondary linear or branched alcohols with ethylene oxide, and products made by condensation of ethylene oxide with the reaction products of propylene oxide and ethylenediamine. Other so-called nonionic detergent compounds include long chain tertiary amine oxides, long chain tertiary phosphine oxides and dialkyl sulfoxides.

The nonionic material may also comprise an alkyl poly saccharide surfactant having the formula RO(CₙH₂ₙO)ₓZ_{y} or RCOO(CₙH₂ₙO)ₓZ_{y}, wherein Z is a moiety derived from a reducing saccharide containing from 5 to 6 carbon atoms, preferably a glucose, galactose, glucosyl or galactosyl residue or mixtures thereof; R is a hydrophobic group selected from the group consisting of alkyl, alkenyl, alkyl phenol, hydroxy alkyl phenyl or hydroxy alkyl groups or mixtures thereof in which the alky groups contain from about 8 to about 20 carbon atoms.

The anionic surfactant component is present in amounts equal to or above a minimum amount at which at least partial removal of stains and soils occurs. The anionic surfactant component is also preferably present in an amount less than the amount at which substantial redeposition of soil occurs. Suitable anionic surfactants for use in compositions of the invention are usually water-soluble alkali metal salts of organic sulfates and sulfonates having alkyl radicals containing from about 8 to about 22 carbon atoms, the term alkyl being used to include the alkyl portion of higher acyl radicals. Examples of suitable synthetic anionic detergent compounds are sodium and potassium alkyl sulfates, especially those obtained by sulfating higher (C₈-C₁₈) alcohols produced, for example, from tallow or coconut oil, sodium and potassium alkyl (C₉-C₂₀) benzene sulfonates, particularly sodium linear secondary alkyl (C₁₀-C₁₅) benzene sulfonates sodium alkyl glyceryl ether sulfates, especially those ethers of the higher alcohols derived from tallow or coconut oil and synthetic alcohols derived from petroleum; sodium coconut oil fatty monoglycerides sulfates and sulfonates.

In the preferred embodiment of the present invention, the anionic surfactant component is present in the amount of from about 0.1% to about 5% by weight of the composition. More preferably, the anionic surfactant component is present in the amount of from about 0.5% to 4% by weight of the composition. More preferably, the anionic surfactant component is present is the amount of from about 1% to about 3% by weight of the composition.

Optimally, the preferred embodiment of the present invention comprises sodium (C₁₁-C₁₅) alkyl benzene sulfonates and sodium (C₁₆-C ₁₈) alkyl sulfates as the anionic surfactant component. However, it should be appreciated that any anionic surfactant may be used.

In the preferred embodiment of the present invention; a detergency builder material is present of which some or all may be electrolytes. The builder material is capable of reducing the level of free calcium ions in the wash liquor and will preferably provide the composition with other beneficial properties such as the generation of an alkaline pH, and the suspension of soil removed from fabric or hard surfaces. The builder is present in the amount of from about 20% to about 60% by weight of the composition. More preferably the builder is present in the amount of from about 25% to about 55% by weight of the composition, and optimally is present in the amount of from about 30% to about 50% by weight of the composition.

In the exemplary embodiment of the present invention, the builder comprises an nonphosphourus containing inorganic builder. When present, include water soluble salts, especially alkali metal carbonates and bicarbonates. Optimally, the builder comprises sodium carbonate, potassium carbonate, sodium and potassium bicarbonates, and mixtures thereof. It should be appreciated, however, that any suitable builder now known or hereinafter known by one skilled in the art may be used.

In the preferred embodiment of the present invention. The chelating agent is present in the amount of from about 0.01% to about 5% by weight of the composition. More preferably, the chelating agent is present in the amount of from about 0.05% to about 3% by weight of the composition, and, optimally, the chelating agent is present from about 0.1% to about 1.5% by weight of the composition.

In the exemplary embodiment of the present invention, the chelating agent can be selected from the group consisting of water soluble amino carboxylates, amino phosphates, poly-functionally substituted aromatic chelating agents and mixtures thereof, all as hereinafter defined and all preferably in their acidic form. In yet a another preferred embodiment of the present invention, the chelating agent is selected from the following amino carboxylates: ethylenediaminetetraacetic acid (EDTA), N-hydroxyethylenediaminetriacetates, nitrilotriacetates (NTA), ethylenediamine tetraproprionates, ethylenediamine-N,N′-diglutameates, 2-hydroxypropylenediamine-N,N′-disuccinates, trieethylenetetraaminehexacetates, diethylenetriaminepentaacetates (DPTA), and ethanoldiglycenes, including their water-soluble salts such as the alkali metal, ammonium, and substituted ammonium salts thereof, and mixtures thereof. Optimally the chelating agent comprises DPTA. It should be noted, however, that any suitable chelating agent now known or hereinafter known in the art may be used.

In the preferred embodiment of the present invention, a bleaching agent is present in the amount from about 30% to about 70% by weight of the composition. In yet a more preferred embodiment of the present invention, the bleaching agent is present in the amount of from about 35% to about 65% by weight of the composition, and, optimally, the bleaching agent is present in the amount of from about 40% to about 60% by weight of the composition.

The exemplary embodiment of the present invention comprises sodium percarbonate as the bleaching agent. More preferably, in the exemplary embodiment of the present invention, the sodium percarbonate is coated with sodium metasilicate to ensure that the sodium percarbonate stays dry when in it's dry state, which improves stability. It should also be noted that any bleaching agent now known, or hereafter known, by those skilled in the art may be used. This includes, but is not limited to, sodium perborate monohydrate, sodium perborate tetrahydrate, persulfates, peracetic acid, hypochlorites, and sodium chlorite.

In the preferred embodiment of the present invention, a buffering agent is present in the amount from less than about 15% by weight of the composition. It is yet more preferred that the buffering agent is present in the amount of from about 5% to about 15% by weight of the composition, and, optimally, the buffering agent is present on the order of about 10% by weight of the composition.

In the exemplary embodiment of the present invention, the buffering agent is selected from borates, citrates, amines, silicates. Optimally, the buffering agent comprises sodium tetraborate pentahydrate. A preferred buffering agent is commercially available as Borax. Sodium tetraborate pentahydrate, preferably Borax, has the ability to pH buffer wash liquor to an effective range to promote bleaching, soil removal and inhibition of redeposition. In addition to the buffering capability, it functions as a deodorizer of body soils in the wash liquor and when used as an all purpose cleaner. The buffering agent should be a mild water soluble abrasive and in hard surface cleaning a degree of abrasion is often needed to physically remove the soil deposits from the surface.

Other aspects that the exemplary embodiment of the present invention may comprise, but are not limited to, include, one or more common additives, such as, for example, a bleach activator and flow aid.

In the exemplary embodiment of the present invention, the bleach activator is selected from, sodium nonanoyloxybenzenesulfonate (SNOBS) and tetraaceticethylene diamine (TAED). Optimally, the bleach activator comprises sodium nonanoyloxybenzenesulfonate (SNOBS).

In another exemplary embodiment of the present invention, the cleaning composition contains sodium alumino silicate hydrate, such as Zeolite A Sodium alumino silicate hydrate acts as a flow aid, which gives the cleaning composition better flow characteristics. Other suitable flow aids include, without limitation, fumed silica and sodium sulfate. Therefore, it should be appreciated that any suitable flow aid now known or hereinafter known by one skilled in the art may be used.

The following is a non-limiting examples of an exemplary embodiment of the present invention:

| Component | Weight % |
|---|---|
| Sodium Tetraborate Pentahydrate | 10.00 |
| Sodium Carbonate | 39.915 |
| Sodium Percarbonate (coated) | 46.90 |
| Sodium alumino silicate hydrate | 0.085 |
| C9-11 ethoxylated alcohol | 0.50 |
| Sodium dodecylbenzenesulfonate | 2.00 |
| DTPA | 0.60 |

The following is another non-limiting example of an exemplary embodiment of the present invention:

| Component | Weight % |
|---|---|
| Sodium Tetraborate Pentahydrate | 10.00 |
| Sodium Carbonate | 39.815 |
| Sodium Percarbonate (coated) | 41.90 |
| Sodium Aluminosilicate Hydrate | 0.085 |
| C9-11 Narrow Range Ethoxylated Alcohol | 0.50 |
| Dodecylbenzenesulfonate | 2.10 |
| DTPA | 0.60 |
| SNOBS | 5.00 |

Any of several common types of dry blending mixers can be used to make this product (eg. ribbon blender, Marion mixer, or Littleford mixer). The following process description is written for batchwise compounding, but could easily be modified for continuous processing.

The sodium carbonate is charged to the mixer, and the agitation is activated to provide a falling curtain or continually moving bed of material and to mix the product. Dodecylbenzenesulfonate is sprayed onto the falling curtain or moving bed of sodium carbonate thereby dry neutralizing it to sodium dodecylbenzenesulfonate in situ. The resulting reaction product should be checked for whiteness to ensure that the reaction is complete before proceeding. Roughly half of the sodium aluminosilicate is added at this stage as a flow aid, then the ethoxylated alcohol is sprayed onto the falling curtain or moving bed of intermediate product. The remaining sodium aluminosilicate is added to reestablish good flow properties, and the remaining ingredients are added to the mixer and mixed until uniform.

It should be understood that the foregoing description of the present invention is of the preferred embodiment of the present invention, and the description is not intended to limit the scope of the invention. The examples of the preferred embodiment are for illustrative purposes only, and the present invention is not limited to the specific examples and compositions set forth herein. Various modifications may be made in light thereof as will be suggested to persons skilled in the art without departing from the scope of the invention as expressed in the claims.

What is claimed is:

1. A powdered cleaning composition comprising:
an anionic surfactant component present in the amount of from about 0.1 to about 5% by weight of the composition;
a nonionic surfactant component present in the amount of from about 0.01 to about 5% by weight of the composition;
a builder present in the amount of from about 20 to about 60% by weight of the composition;
a chelating agent present in the amount of from about 0.01 to about 5% by weight of the composition;
a bleaching agent present in the amount of from about 30 to about 70% by weight of the composition; and
a buffering agent present in the amount of from about 0 to about 15% by weight of the composition.

2. The composition of claim 1, wherein the anionic surfactant component comprises sodium dodeclbenzenesulfonate

3. The composition of claim 1, wherein the nonionic surfactant component comprises C9-11 ethoxylated alcohols.

4. The composition of claim 1, wherein the builder comprises sodium carbonate.

5. The composition of claim 1, wherein the chelating agent comprises diethylenetriaminepentaacetic acid (DTPA).

6. The composition of claim 1, wherein the bleaching agent comprises sodium percarbonate.

7. The composition of claim 6, wherein the sodium percarbonate is coated with sodium metasilicate.

8. The composition of claim 1, wherein in the buffering agent comprises sodium tetraborate pentahydrate.

9. The composition of claim 1, further comprising a bleach activator.

10. The composition of claim 9, wherein said bleach activator comprises nonanoyloxybenzenesulfonate.

11. The composition of claim 1, further comprising sodium alumino silicate hydrate.

12. A powdered cleaning composition comprising:
an anionic surfactant component present in the amount of from about 0.1 to about 5% by weight of the composition;
a nonionic surfactant component present in the amount of from about 0.01 to about 5% by weight of the composition;
a builder present in the amount of from about 20 to about 60% by weight of the composition;
a chelating agent present in the amount of from about 0.01 to about 5% by weight of the composition;
a bleaching agent present in the amount of from about 30 to about 70% by weight of the composition;
a buffering agent present in the amount of from about 0 to about 15% by weight of the composition; and
sodium alumino silicate hydrate present in the amount of from about 0 to about 0.5% by weight of the composition.

13. The composition of claim 12, wherein the anionic surfactant component comprises sodium dodeclbenzenesulfonate

14. The composition of claim 12, wherein the nonionic surfactant component comprises C9-11 ethoxylated alcohols.

15. The composition of claim 12, wherein the builder comprises sodium carbonate.

16. The composition of claim 12, wherein the chelating agent comprises diethylenetriaminepentaacetic acid (DTPA).

17. The composition of claim 12, wherein the bleaching agent comprises sodium percarbonate.

18. The composition of claim 17, wherein the sodium percarbonate is coated with sodium metasilicate.

19. The composition of claim 12, wherein in the buffering agent comprises sodium tetraborate pentahydrate.

20. The composition of claim 12, further comprising a bleach activator.

21. The composition of claim 20, wherein said bleach activator comprises nonanoyloxybenzenesulfonate.
